(19) United States
(12) Patent Application Publication
(10) Pub. No.: US 2010/0245471 A1
(43) Pub. Date: Sep. 30, 2010

(54) Liquid droplet ejection head module, liquid droplet ejection head, and liquid droplet ejecting apparatus

(75) Inventor: Kazuo Sanada, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/659,996

(22) Filed: Mar. 26, 2010

(30) Foreign Application Priority Data
Mar. 31, 2009 (JP) 2009-085270

(51) Int. Cl. B41J 2/145

(52) U.S. Cl. 347/40

(57) ABSTRACT

There is provided a liquid droplet ejection head module comprising: a plurality of ejection surfaces, each ejection surface comprising a pair of first sides extending in a direction intersecting with a first direction, and a pair of second sides linking the pair of first sides and extending in a direction inclined with respect to the first direction; first nozzles that are provided on the ejection surfaces; and second nozzles that are provided on the ejection surfaces, wherein, when the plurality of ejection surfaces are linearly arranged such that the second sides overlap and the first nozzles and the second nozzles are projected in a direction orthogonal to the first direction, the projected first nozzles and the second nozzles are arranged in equal intervals in the direction orthogonal to the first direction.

### CROSS-REFERENCE TO RELATED APPLICATION

This application claims priority under 35 USC 119 from Japanese Patent Application No. 2009-085270 filed on Mar. 31, 2009, the disclosure of which is incorporated by reference herein.

### BACKGROUND

1. Technical Field

The present invention relates to a liquid droplet ejection head module, a liquid droplet ejection head, and a liquid droplet ejecting apparatus, and more particularly, to a liquid droplet ejection head module where arrangement of nozzles provided on a liquid droplet ejection surface and an external shape of the liquid droplet ejection surfaces are optimized, a liquid droplet ejection head, and a liquid droplet ejecting apparatus.

2. Related Art

As an example of a liquid droplet ejecting apparatus, inkjet recording apparatuses that eject liquid droplets, such as ink, from nozzles of a liquid droplet ejection head, and form images on a recording medium, such as paper, are disclosed (for example, refer to Japanese Patent Application Laid-Open (JP-A) Nos. 06-99593, 2002-67317, and 2003-48318). In JP-A Nos. 06-99593, 2002-67317, and 2003-48318, nozzle groups of plural colors are disposed on the same recording head.

### SUMMARY

However, JP-A Nos. 06-99593, 2002-67317, and 2003-48318 do not describe a method in which arrangement of nozzles of plural colors provided on an ejection surface and an external shape of the ejection surface are optimized, and external shapes of nozzle surfaces where heads formed of a wafer using a semiconductor process can be cut from the individual wafers efficiently and nozzle arrangement where the cut-out heads are linearly arranged and droplet ejecting points can be determined without gaps between the heads are realized.

The present invention has been made in view of the above circumstances, and it is an object of the present invention to provide a liquid droplet ejection head module, a liquid droplet ejection head, and a liquid droplet ejecting apparatus by which plural kinds of droplets can be ejected, and that has both an external shape of nozzle surface where heads formed by using a semiconductor process can be cut from the individual wafers without leaving waste wafers and nozzle arrangement where the cut-out heads are linearly arranged and droplet ejecting points can be determined without gaps between the heads.

This invention has been made in view of the above circumstance and provides a liquid droplet ejection head module, a liquid droplet ejection head, and a liquid droplet ejecting apparatus. The liquid droplet ejection head module according to a first aspect of the present invention includes a plurality of ejection surfaces, each ejection surface comprising a pair of first sides extending in a direction intersecting with a first direction and a pair of second sides linking the pair of first sides and extending in a direction inclined with respect to the first direction; first nozzles that are provided on the plurality of ejection surfaces and arranged in the direction inclined to the first direction and in a direction substantially orthogonal to the first direction, and that eject first liquid droplets; and second nozzles that are provided on the plurality of ejection surfaces so as to be oriented further downstream in the first direction than the first nozzles and arranged in the direction inclined to the first direction and the direction substantially orthogonal to the first direction, and that eject second liquid droplets, wherein, when the plural ejection surfaces are linearly arranged such that the second sides overlap and the first nozzles are projected in a direction orthogonal to the first direction, the projected first nozzles are arranged in equivalent intervals in the direction orthogonal to the first direction, and when the second nozzles are projected in the direction orthogonal to the first direction, the projected second nozzles are arranged in equivalent intervals in the direction orthogonal to the first direction.

### BRIEF DESCRIPTION OF THE DRAWINGS

FIG. 1 is a lateral cross-sectional view illustrating the schematic configuration of an inkjet recording apparatus according to an exemplary embodiment of the present invention;

FIG. 2 is a lateral cross-sectional view of surrounding sections of nozzles of a recording head according to the exemplary embodiment of the present invention;

FIG. 3 is a plan view illustrating nozzle surfaces of the recording head according to the exemplary embodiment of the present invention; and

FIG. 4 is a plan view illustrating cutting lines when the recording head according to the exemplary embodiment of the present invention is cut.

### DETAILED DESCRIPTION OF THE PRESENT INVENTION

Hereinafter, an exemplary embodiment of the present invention will be described in detail with reference to the drawings attached hereto. In the exemplary embodiment below, the case where the present invention is applied to an inkjet recording apparatus to eject ink droplets and record images on a recording medium will be described.

[Inkjet Recording Apparatus]

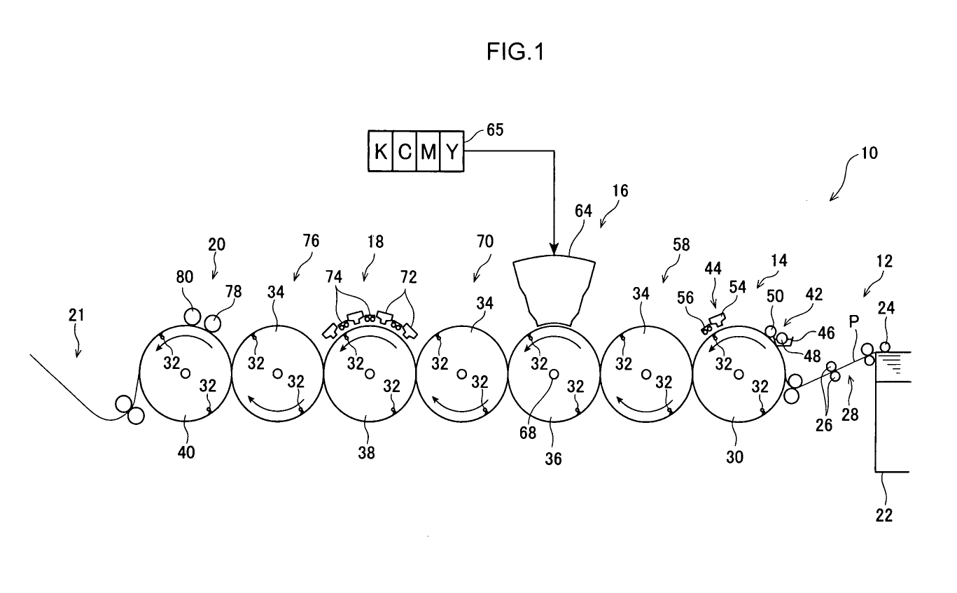

FIG. 1 illustrates the whole configuration of an inkjet recording apparatus 1.

As illustrated in FIG. 1, in the inkjet recording apparatus 10, on the upstream side of a conveyance direction (hereinafter, simply referred to “upstream side”) of sheets P (hereinafter, referred to “paper P”) serving as recording media, a paper feed conveyance section 12 that feeds and conveys the paper P is provided. On the downstream side of the paper feed conveyance section 12, along the conveyance direction of the paper P, a treatment liquid applying section 14 applying a treatment liquid onto a recording surface of the paper P, an image recording section 16 that records an image on the recording surface of the paper P, an ink drying section 18 that dries the image formed on the recording surface, an image fixing section 20 that fixes the dried image on the paper P, and a discharge section 21 that discharges the paper P where the image is fixed are provided. Hereinafter, the individual processing sections will be described.

(Paper Feed Conveyance Section)

A stack section 22 where the paper P are stacked is provided in the paper feed conveyance section 12 and a feed section 24 that feeds each of the paper P stacked on the stack section 22 is provided on the stack section 22. On the downstream side of the conveyance direction of the paper P of the feed section 24 (hereinafter, the “conveyance direction of the paper P” may be omitted), a conveyance section 28 that is composed of pairs of rollers 26 is provided. The paper P that is fed by the feed section 24 is conveyed to the treatment liquid applying section 14 through the conveyance section 28 composed of the pairs of rollers 26.

(Treatment Liquid Applying Section)

In the treatment liquid applying section 14, a treatment liquid applying drum 30 is disposed to freely rotate. In the treatment liquid applying drum 30, a holding member 32 that nips a front end of the paper P and holds the paper P is provided. The paper P is conveyed to the downstream side by the rotation of the treatment liquid applying drum 30, in a state where the paper P is held on a surface of the treatment liquid applying drum 30 by the holding member 32.

As the treatment liquid applying drum 30, the holding member 32 is provided on an intermediate conveying drum 34, an image forming drum 36, an ink drying drum 38, and an image fixing drum 40, all of which are to be described in detail below. The paper P is delivered from an upstream-side drum to a downstream-side drum, by the holding member 32.

On the treatment liquid applying drum 30, a treatment liquid applying device 42 and a treatment liquid drying device 44 are disposed along a circumferential direction of the treatment liquid applying drum 30. A treatment liquid is applied to the recording surface of the paper P by the treatment liquid applying device 42, and the treatment liquid is dried by the treatment liquid drying device 44.

Then, the treatment liquid reacts with the ink to aggregate a color material (pigment), and separates and urges to separate the color material (pigment) from a solvent. In the treatment liquid applying device 42, a storage section 46 that stores the treatment liquid is provided, and a portion of a gravure roller 48 is soaked in the treatment liquid.

A rubber roller 50 is disposed so as to be pressure contacted with the gravure roller 48. The rubber roller 50 contacts the recording surface of the paper P and the treatment liquid is applied. A squeegee (not illustrated) contacts with the gravure roller 48 and controls the amount of treatment liquid that is applied to the recording surface of the paper P.

Meanwhile, in the treatment liquid drying device 44, hot air nozzles 54 and infrared heaters 56 (hereinafter, referred to “IR heaters 56”) are disposed close to the surface of the treatment liquid applying drum 30. By the hot air nozzles 54 and the IR heaters 56, a solvent, such as water, in the treatment liquid is evaporated and a solid or a thin-film treatment liquid layer is formed on the recording surface of the paper. By forming a thin layer of the treatment liquid by a treatment liquid drying process, ink dots that are formed by ink-ejection at the image recording section 16 come into contact with the surface of the paper, and a necessary dot diameter is obtained. In addition, the ink dots react with the treatment liquid forming the thin layer to aggregate the color material, and are fixed on the surface of the paper.

Then, the paper P where the treatment liquid is thus applied to the recording surface by the treatment liquid applying section 14 and dried is conveyed to an intermediate conveying section 58 that is provided between the treatment liquid applying section 14 and the image recording section 16.

(Intermediate Conveying Section)

In the intermediate conveying section 58, the intermediate conveyance drum 34 is rotatably provided. The paper P is held on the surface of the intermediate conveying drum 34 by the holding member 32 provided on the intermediate conveying drum 34, and the paper P is conveyed to the downstream side by the rotation of the intermediate conveying drum 34.

(Image Recording Section)

In the image recording section 16, the image forming drum 36 is rotatably provided. The paper P is held on the surface of the image forming drum 36 by the holding member 32 provided on the image forming drum 36, and the paper P is conveyed to the downstream side by the rotation of the image forming drum 36.

Over the image forming drum 36, an inkjet line head (hereinafter, simply referred to “head”) 64 of a single path type is disposed to come close to the surface of the image forming drum 36. In the head 64, nozzles that eject droplets of at least YMCK (“Y” for yellow, “M” for magenta, “C” for cyan, “K” for black, all of which are basic colors) are arranged. Images of the individual colors are recorded on the treatment liquid layer formed on the recording surface of the paper at the treatment liquid applying section 14.

The treatment liquid causes the color material (pigment) and latex particles dispersed in the ink to aggregate with the treatment liquid, and forms an aggregate so that a flow of the color material would not occur on the paper P. For example, acid is incorporated in the treatment liquid so as to destroy pigment dispersion and aggregate the color material by lowering the Ph when contacting ink droplets with the treatment liquid. Thus, blotting of the color material on the paper P, mingling of ink dots of different colors, and interference of droplet ejection caused by mingling of ink droplets when landing on the paper P can be prevented.

The head 64 can be constituted so that ink droplets are ejected in synchronization with an encoder (not illustrated) disposed at the image forming drum 36 to detect a rotation speed thereof so as to precisely determine landing location of the ink droplets, and thus, irregularity of ink droplet ejecting position due to deflection of the image forming drum 36, deviation of the axis of the rotating shaft 68, and drum surface speed irregularity can be reduced.

The head 64 is provided so as to be moved away from the upper side of the image forming drum 36, and the maintenance operation, such as cleaning of the nozzle surface or discharging of viscosity increasing ink, is carried out in a condition that the head 64 is moved away from the upper side of the image forming drum 36.

The inkjet recording apparatus 10 includes an ink storing/charging section 65 that stores ink supplied to nozzle groups of the individual colors of the head 64. The ink storing/charging section 65 has ink tanks that store ink of the colors corresponding to the nozzle groups of each color of the head 64, and each of the ink tanks communicates with the nozzle group of each color of the head 64 through a predetermined conduit.

In the image recording section 16, the paper P on which recording surface the image is recorded is conveyed to the intermediate conveying section 70 provided between the image recording section 16 and the ink drying section 18, by the rotation of the image forming drum 36. In this case, however, since the configuration of the intermediate conveying section 70 is almost equal to the configuration of the intermediate conveying section 58, the description thereof is omitted.

(Ink Drying Section)

In the ink drying section 18, the ink drying drum 38 is rotatably provided. Over the ink drying drum 38, hot air nozzles 72 and IR heaters 74 are provided to come close to the surface of the ink drying section 18.

For example, the hot air nozzles 72 are configured so as to be disposed on the most upstream and most downstream sides, and each pair of IR heaters 74 that is disposed parallel to the hot air nozzles 72 and each hot air nozzle 72 are alternately disposed. The hot air nozzle 72 and the IR heater 74 and the hot air nozzle 72 can be arranged in a configuration other than the above configuration. For example, the IR heaters 74 may be disposed on the upstream side, heat energies may be irradiated at the upstream side to increase the temperature of the moisture, and the hot air nozzles 72 may be disposed on the downstream side to blow off saturated water vapor.

The hot air nozzles 72 are disposed at a hot air blowing angle inclined to the side of a rear end of the paper R Thereby, a flow of the hot air by the hot air nozzles 72 can be converged in one direction, and thus, the paper P can be pressed onto the surface of the ink drying drum 38 so as to be held on the surface of the ink drying drum 38.

By the hot air blown by the hot air nozzles 72 and the IR heaters 74, in a portion of the paper P where the image is recorded, the solvent that is separated by the color material aggregation is dried and a thin image layer is formed.

The temperature of the hot air can be changed in accordance with the conveyance speed of the paper P but is generally set from 50° C. to 70° C. When the temperature of the IR heater 74 is set from 200° C. to 600° C., the ink surface temperature is set to become 50° C. to 60° C. The evaporated solvent and the air are discharged to the outside of the inkjet recording apparatus 10, but the air is collected. The air may be cooled down by a cooler/radiator and the solvent in the air may be collected as a liquid.

The paper P of which image on the recording surface is dried is conveyed to the intermediate conveying section 76 provided between the ink drying section 18 and the image fixing section 20, by the rotation of the ink drying drum 38. Since the configuration of the intermediate conveying section 76 is almost equal to the configuration of the intermediate conveying section 58, the description thereof is omitted.

(Image Fixing Section)

In the image fixing section 20, the image fixing drum 40 is rotatably provided. The image fixing section 20 has a function of heating/pressurizing the latex particles in the thin image layer that is formed on the ink drying drum 38 so as to melt and fix the latex particles on the paper P.

On the image fixing drum 40, a heating roller 78 is disposed close to the surface of the image fixing drum 40. The heating roller 78 includes a metal tube that is made of aluminum having superior heat conduction and a halogen lamp that is assembled in the metal tube. The heating roller 78 provides heat energy to the paper P so as to raise the temperature thereof to the Tg temperature of the latex or above. Thereby, the heating roller 78 melts the latex particles, push the latex particles into the unevenness of the paper, and fix the latex particles, as well as leveling the unevenness of the image surface and providing glossies thereto.

On the downstream side of the heating roller 78, a fixing roller 80 is provided. The fixing roller 80 is disposed to come into pressure contact with the surface of the image fixing drum 40, and obtains a nip force with the image fixing drum 40. For this reason, at least one of the fixing roller 80 and the image fixing drum 40 is configured to have an elastic layer formed on its surface and have the uniform nip width with respect to the paper P.

By the above-described processes, the paper P where the image of the recording surface is fixed is conveyed to the discharge section 21 provided on the downstream side of the image fixing section 20, by the rotation of the image fixing drum 40.

In this exemplary embodiment, the image fixing section 20 has been described. However, since the image that is formed on the recording surface may be dried and fixed by the ink drying section 18, the image fixing section 20 can be omitted.

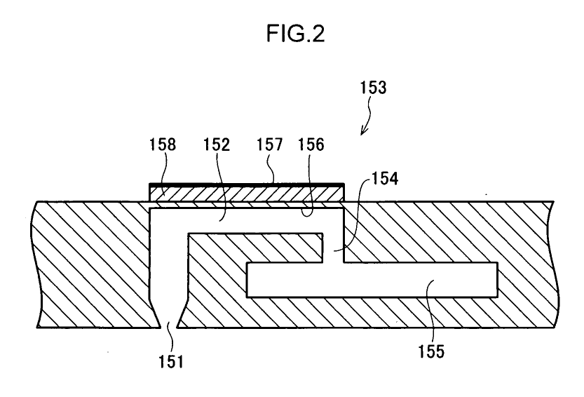

FIG. 2 is a cross-sectional view illustrating the three-dimensional configuration of a liquid droplet ejecting element (ink chamber unit corresponding to one nozzle 204) that is provided for each nozzle of the head 64. As illustrated in FIG. 2, each pressure chamber 152 communicates with a common flow channel 155 through a supply slot 154. The common flow channel 155 communicates with an ink tank (not illustrated) that is an ink supply source, and the ink that is supplied from the ink tank is distributed to each pressure chamber 152 through the common flow channel 155.

An actuator 158 that includes an individual electrode 157 is bonded to a pressurizing plate (vibration plate also used as a common electrode) 156 constituting a surface (ceiling surface in FIG. 2) of a portion of the pressure chamber 152. If a driving voltage is applied between the individual electrode 157 and the common electrode, the actuator 158 deforms and a volume of the pressure chamber 152 changes. As a result, the pressure changes, and ink are ejected from the nozzles 204. In the actuator 158, a piezoelectric element that uses a piezoelectric substance, such as lead zirconium titanate or barium titanate, is preferably used. After the ink is ejected, when the displacement of the actuator 158 is restored, new ink is refilled into the pressure chamber 152 thorough the supply port 154 from the common flow channel 155.

Therefore, in the inkjet recording apparatus 10 according to this exemplary embodiment, by controlling driving of the actuator 158 corresponding to each nozzle 204 according to dot arrangement data generated from image information, the ink droplets can be ejected from the nozzles 204. In the inkjet recording apparatus 10 according to this exemplary embodiment, while the paper P is conveyed in a predetermined direction at a constant speed, ink ejecting timing of each nozzle 204 is controlled according to a conveyance speed. As a result, a desired image can be recorded on the paper P.

In this exemplary embodiment, a method of ejecting ink droplets by the deformation of the actuator 158 represented as a piezo element (piezoelectric element) is adopted. However, the method that ejects the ink is not limited in particular. Instead of the piezojet method, various methods can be adopted. For example, a thermal jet method of heating the ink by a heating element, such as a heater, generating air bubbles, and ejecting ink droplets by the pressure can be adopted.

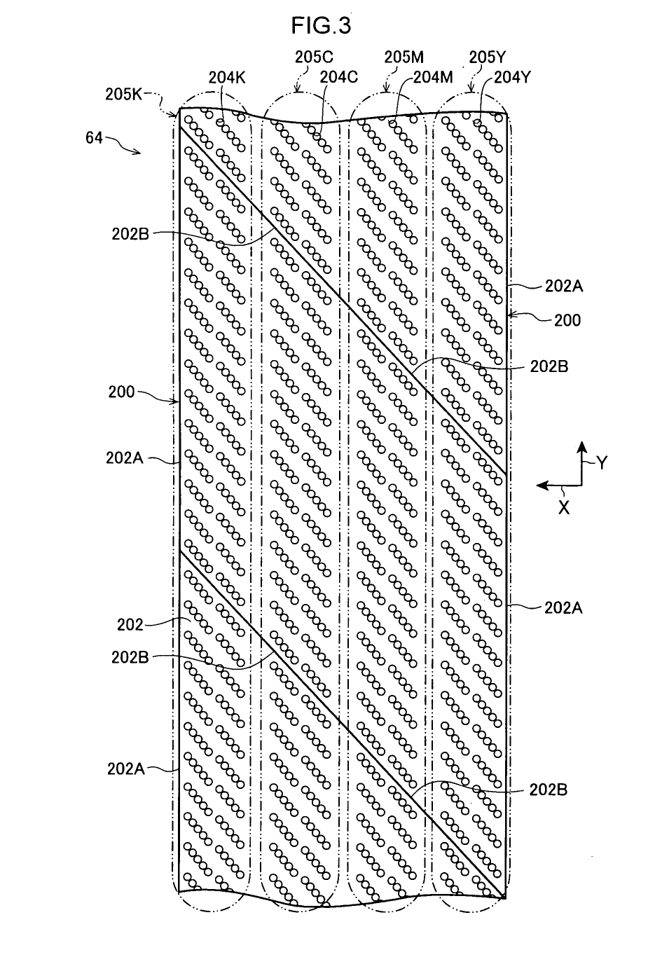

Next, the configuration of the head 64 will be described. As illustrated in FIG. 3, the head 64 is formed by linearly arranging plural head modules 200 in a direction (arrow Y) orthogonal to a conveyance direction (main scanning direction X) of the paper P. In this exemplary embodiment, the conveyance direction (main scanning direction) of the paper P indicates a first direction.

An ejection surface 202 of the head module 200 is surrounded by a pair of first sides 202A that are parallel to each other and a pair of second sides 202B that are also parallel to each other. The first sides 202A extend in a direction that crosses the conveyance direction, and the second sides 202B link the pair of parallel first sides 202A and extend in a direction inclined to the conveyance direction. In this exemplary embodiment, the first sides 202A extend along the direction orthogonal to the conveyance direction, and an external shape of the ejection surface 202 is approximately a parallelogram.

On the ejection surface 202, a plurality of nozzles 204Y that eject yellow ink are formed. The nozzles 204Y are arranged in a direction inclined to the conveyance direction and a direction substantially orthogonal to the conveyance direction (including a direction shallowly inclined to the orthogonal direction). An aggregate of the nozzles 204Y is called a nozzle group 205Y.

On the ejection surface 202, nozzles 204M that eject magenta ink are formed to be closer to the downstream side of the conveyance direction than the nozzle group 205Y. The nozzles 204M are arranged in a direction inclined to the conveyance direction and a direction substantially orthogonal to the conveyance direction (including a direction shallowly inclined to the orthogonal direction). An aggregate of the nozzles 204M is called a nozzle group 205M.

On the ejection surface 202, nozzles 204C that eject cyan ink are formed to be closer to the downstream side of the conveyance direction than the nozzle group 205M. The nozzles 204C are arranged in a direction inclined to the conveyance direction and a direction substantially orthogonal to the conveyance direction (including a direction shallowly inclined to the orthogonal direction). An aggregate of the nozzles 204C is called a nozzle group 205C.

On the ejection surface 202, nozzles 204K that eject black ink are formed to be closer to the downstream side of the conveyance direction than the nozzle group 205C. The nozzles 204K are arranged in a direction inclined to the conveyance direction and a direction substantially orthogonal to the conveyance direction (including a direction shallowly inclined to the orthogonal direction). An aggregate of the nozzles 204K is called a nozzle group 205K.

When the colors corresponding to the nozzles 204 or the nozzle group 205 is distinguished from each other, corresponding Y, M, C, and K are added to tails of symbols, respectively. When the corresponding colors are not distinguished from each other, Y, M, C, and K are omitted.

On the ejection surface 202, the plural nozzle groups are formed. Since the nozzles 204 are arranged in a direction inclined to the conveyance direction, that is, the nozzles 204 are dispersed with respect to the conveyance direction. Therefore, distribution of the nozzles 204 in a direction orthogonal to the conveyance direction is in a high density. Thereby, the nozzle groups 205 enable a high-density record with respect to the conveyance direction.

As illustrated in FIG. 3, the head 64 is formed by linearly arranging the ejection surfaces 202, such that the second sides 202B overlap each other. Here, when nozzles 204Y are projected in the direction orthogonal to the conveyance direction, the projected nozzles 204Y are arranged in equivalent intervals in the direction orthogonal to the conveyance direction. When the nozzles 204M are projected in the direction orthogonal to the conveyance direction, the projected nozzles 204M are arranged in equivalent intervals in the direction orthogonal to the conveyance direction. When the nozzles 204C are projected in the direction orthogonal to the conveyance direction, the projected nozzles 204C are arranged in equivalent intervals in the direction orthogonal to the conveyance direction. When the nozzles 204K are projected in the direction orthogonal to the conveyance direction, the projected nozzles 204K are arranged in equivalent intervals in the direction orthogonal to the conveyance direction.

Hereinafter, a setting method of the second sides 202B of the head module will be described together with a cutting process of the head module 200.

The head module 200 according to this exemplary embodiment is obtained by using a semiconductor process known in the related art, setting a flat silicon wafer provided with nozzles or piezoelectric elements to a dicing machine having a rotary blade that can be scanned in two axial directions, and cutting the portion corresponding to the head module from the silicon wafer.

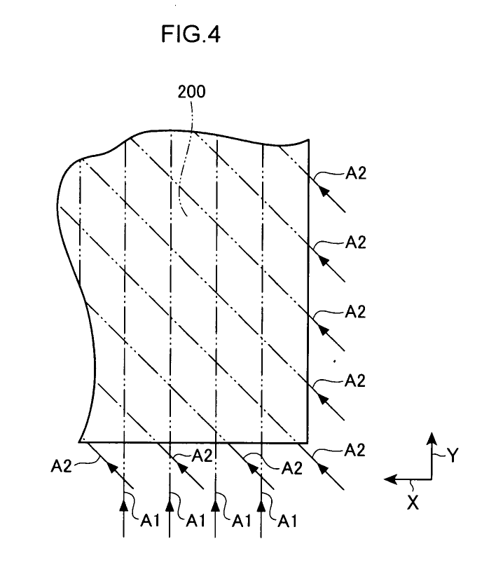

Cutting lines along which the head module 200 is cut from the silicon wafer are all linear as illustrated in FIG. 4. The cutting lines Al that extend in one direction (Y direction in FIG. 4) form the first sides 202A of the head module 200, and the cutting lines A2 that extend in the other direction (direction inclined to an X direction (direction orthogonal to the Y direction) in FIG. 4) form the second sides 202B of the head module 200.

The cutting lines A1 are determined such that each of the nozzle groups 205Y to 205K of the individual colors are cut as one aggregate, and each of the nozzle groups 205Y to 205K is included in the head module 200. The cutting lines A2 are determined to pass spaces between inclined nozzle trains of the nozzle groups 205Y to 205K of the individual colors. The cutting lines A2 do not necessarily pass the centers of the nozzle trains. However, when the cutting lines A2 pass the centers of the nozzle trains, a margin can be set to the intersection of dimensions without considering interference between edges of the second sides 202B of the head module 200.

As such, since the external shape of the ejection surface 202 is approximately a parallelogram, by linearly cutting along the cutting lines A1 and A2, the head module 200 can be cut from the silicon wafer. Thereby, the head module 200 can be cut from the silicon wafer in a short time. Since the head module 200 can be cut from one piece of silicon wafer efficiently, the heads formed of a wafer using the semiconductor process can be cut from the individual wafers efficiently. That is, the number of silicon wafer obtained per silicon wafer increases and a cost decreases.

The head modules 200 cut from wafers are linearly arranged such that the second sides 202B of the ejection surface 202 overlap each other, and the long head 64 is formed. By arranging the head modules 200 such that the second sides 202B of the ejection surface 202 overlap each other, the head modules 200 can be disposed with high precision (position precision of the nozzles).

Next, the function of the inkjet recording apparatus 10 according to this exemplary embodiment will be described.

In this exemplary embodiment, the paper P is fed from the stack section 22 by the feed section 24 and is conveyed to the treatment liquid applying section 14 through the conveyance section 28. In the treatment liquid applying section 14, the treatment liquid is applied to the recording surface of the paper P and is then dried. Then, the paper P is conveyed to the image recording section 16 through the intermediate conveying section 58, and is held on the surface of the image forming drum 36. In the image recording section 16, the ink droplets are ejected from the nozzles 204 of the head 64 to the recording surface of the paper P in accordance with the image information. Thereby, in the recording surface of the paper P, an image that is indicated by the image information is recorded.

In the image recording section 16, the paper P where the image is recorded on the recording surface is conveyed to the ink drying section 18 through the intermediate conveying section 70. In the ink drying section 18, the solvent that is incorporated in the ink on the recording surface of the paper P is dried. Then, the paper P is conveyed to the image fixing section 20 through the intermediate conveying section 76. In the image fixing section 20, a fixing process of the image that is recorded on the recording surface of the paper P is carried out. The paper P on which the recording surface the image is fixed is conveyed to the discharge section 21 by the rotation of the image fixing drum 40.

In this exemplary embodiment, since the nozzle groups 205Y to 205K of the plural colors are formed in the head 64, for example, as compared with the configuration where the heads are prepared for every color and arranged in the conveyance direction, the positions of the nozzles of the individual colors are not necessarily aligned. That is, since the nozzle groups 205Y to 205K of the plural colors are formed on the same head 64, the nozzles of the individual colors are arranged in a high precision. Further, the positional adjustment (nozzle position alignment) of the heads of the individual colors does not need to be performed in order to improve the precision of the nozzle positions.

The head 64 is formed by linearly arranging the head modules 200. When the nozzles 204 are projected in the direction orthogonal to the conveyance direction, the interval of the projected nozzles 204 in the direction orthogonal to the conveyance direction becomes an equivalent interval. Therefore, high-density recording is enabled with respect to the direction orthogonal to the conveyance direction.

As described above, the inkjet recording apparatus 10 according to this exemplary embodiment can eject plural kinds of liquid droplets, and realize the external shape of the nozzle surface where the heads formed of a wafer using the semiconductor process can be cut from the wafer efficiently and the nozzle arrangement where the heads can be linearly disposed and the droplet ejecting points can be determined without the gaps between the heads.

In the above-described exemplary embodiment, the configuration where the nozzle groups of the four colors of YMCK are formed in the head module 200 is used. However, the present invention is not limited to the above configuration and the configuration where nozzle groups of two colors or three colors are formed or the configuration where nozzle groups of five colors or more are formed may be used.

In this exemplary embodiment, the long and fixed head 64 is formed by linearly arranging the head modules 200. However, the present invention is not limited to the above configuration, and the head module 200 may be mounted in a carriage that moves in a direction orthogonal to the conveyance direction of the paper P. In this case, a direction of the arrow Y in FIG. 3 becomes a movement direction of the carriage.

The present invention is not limited to the above-described exemplary embodiment, and various modifications, changes, and improvements can be made.

In the exemplary embodiment, the recording head of the inkjet printer that ejects the ink is exemplified. However, the present invention is not limited thereto, and can be applied to general liquid droplet ejecting apparatuses that are used for various industrial objects, such as manufacturing of a color filter for display that ejects colored ink to a polymer film, forming of an EL display panel that ejects an organic EL solvent to a substrate, and performing an etching process by solution ejecting to manufacture a print circuit board.

In the liquid droplet ejecting apparatus, since the first nozzle group including the first nozzles ejecting the first liquid droplets and the second nozzle group including the second nozzles ejecting the second liquid droplets are provided on the same ejection surface, plural kinds of liquid droplets can be ejected.

The ejection surface is configured by the pair of first sides extending in the direction crossing the first direction and the pair of second sides linking the pair of first sides and extending in the direction inclined to the first direction, that is, the external shape of the ejection surface becomes the parallelogram. Therefore, the external shape of the liquid droplet ejection surface is configured as the shape where the plural heads are formed in the silicon wafers using the semiconductor process and the individual heads can be cut from the individual silicon wafers efficiently.

Specifically, when the silicon wafer is cut into each die (head) using the common dicing machine, the rotary blade is scanned in the two axial directions different from each other and cut the silicon wafer. Since the rotary blade can freely select the two axes, if the external shape of the head can be configured as the parallelogram, for example, the head can be cut from the silicon wafer efficiently, and the number of heads acquired per silicon wafer increases and a cost decreases.

Since the first nozzles are disposed even in a direction inclined to the first direction, that is, distributing and disposing the first nozzles in a depthwise direction (first direction) of the projection, the first nozzles is distributed in the direction orthogonal to the first direction in a high density. Since the second nozzles are disposed even in the direction inclined to the first direction, that is, distributing and disposing the second nozzles in the depth-wise direction (first direction) of the projection, the interval of the second nozzles are distributed in the direction orthogonal to the first direction in a high density. Thereby, the first nozzle group and the second nozzle group enable high-density recording.

Since the plural liquid droplet ejection head modules are arranged so that are linearly the second sides of each ejection surface overlap each other, when the first nozzles are projected in the direction orthogonal to the first direction, the projected first nozzles are arranged in equivalent intervals in the direction orthogonal to the first direction. When the second nozzles are projected in the direction orthogonal to the first direction, the projected second nozzles are arranged in equivalent intervals in the direction orthogonal to the first direction. That is, the liquid droplet ejection head module of the present application can satisfy a single path aptitude. The single path aptitude indicates the nozzle arrangement of the ejection surface or the external shape thereof where the droplets can be ejected even from the nozzles of the portion overriding the heads in the same intervals as those of the other portions, when the cut-out heads are linearly arranged.

As described above, according to the above configuration, plural kinds of liquid droplets can be ejected, and the external shape of the nozzle surface where the heads formed of a wafer using the semiconductor process can be cut from the individual wafers efficiently and the nozzle arrangement where the cut-out heads are linearly arranged and the droplet ejecting points can be determined without the gaps between the heads can be realized.

A liquid droplet ejection head according to a second aspect of the present invention includes the plural liquid droplet ejection head modules according to the first aspect. The plural ejection surfaces are linearly arranged such that the second sides overlap.

According to the liquid droplet ejection head of the second aspect, the liquid droplet ejection head is formed by linearly arranging the plural ejection surfaces of the plural liquid droplet ejecting modules such that the second sides overlap. Therefore, high-density recording is enabled with respect to the direction orthogonal to the first direction without gaps.

A liquid droplet ejecting apparatus according to a third aspect of the present invention includes the liquid droplet ejection head module according to the first aspect.

According to the liquid droplet ejecting apparatus of the third aspect, similar to the liquid droplet ejection head module of the first aspect, plural kinds of liquid droplets can be ejected, and external shapes of nozzle surfaces where heads formed of a wafer using a semiconductor process can be cut from the individual wafers efficiently and nozzle arrangement where the cut-out heads are linearly arranged and droplet ejecting points can be determined without gaps between the heads can be realized.

As described above, according to the liquid droplet ejection head module, the liquid droplet ejection head, and the liquid droplet ejecting apparatus of the present invention, plural kinds of liquid droplets can be ejected, and external shapes of nozzle surfaces where heads formed of a wafer using a semiconductor process can be cut from the individual wafers efficiently and nozzle arrangement where the cut-out heads are linearly arranged and droplet ejecting points can be determined without gaps between the heads can be realized.

The foregoing description of the exemplary embodiments of the present invention has been provided for the purpose of illustration and description. It is not intended to be exhaustive or to limit the present invention to the precise forms disclosed. Obviously, many modifications and variations will be apparent to practitioners skilled in the art. The exemplary embodiments were chosen and descried in order to best explain the principles of the present invention and its practical applications, thereby enabling others skilled on the art to understand the present inventions for various embodiments and with the various modifications as are suited to the particular use contemplated. It is intended that the scope of the present inventions be defined by the following claims and their equivalents.

1. A liquid droplet ejection head module comprising:
a plurality of ejection surfaces, each ejection surface comprising a pair of first sides extending in a direction intersecting with a first direction, and a pair of second sides linking the pair of first sides and extending in a direction inclined with respect to the first direction;
first nozzles that are provided on the plurality of ejection surfaces and arranged in the direction inclined to the first direction and in a direction substantially orthogonal to the first direction, and that eject first liquid droplets; and
second nozzles that are provided on the plurality of ejection surfaces so as to be further downstream in the first direction than the first nozzles and arranged in the direction inclined to the first direction and in the direction substantially orthogonal to the first direction, and that eject second liquid droplets,
wherein, when the plurality of ejection surfaces are linearly arranged such that the second sides overlap and the first nozzles are projected in a direction orthogonal to the first direction, the projected first nozzles are arranged in equal intervals in the direction orthogonal to the first direction, and when the second nozzles are projected in the direction orthogonal to the first direction, the projected second nozzles are arranged in equal intervals in the direction orthogonal to the first direction.

2. A liquid droplet ejection head comprising a plurality of liquid droplet ejection head modules comprising:
plurality of ejection surfaces, each ejection surface comprising a pair of first sides extending in a direction intersecting with a first direction, and a pair of second sides linking the pair of first sides and extending in a direction inclined with respect to the first direction;
first nozzles that are provided on the plurality of ejection surfaces and arranged in the direction inclined to the first direction and in a direction substantially orthogonal to the first direction, and that eject first liquid droplets; and
second nozzles that are provided on the plurality of ejection surfaces so as to be further downstream in the first direction than the first nozzles and arranged in the direction inclined to the first direction and in the direction substantially orthogonal to the first direction, and that eject second liquid droplets,
wherein, when the plurality of ejection surfaces are linearly arranged such that the second sides overlap and the first nozzles are projected in a direction orthogonal to the first direction, the projected first nozzles are arranged in equal intervals in the direction orthogonal to the first direction, and when the second nozzles are projected in the direction orthogonal to the first direction, the projected second nozzles are arranged in equal intervals in the direction orthogonal to the first direction,
wherein the plurality of ejection surfaces are linearly arranged such that the second sides overlap.

3. A liquid droplet ejection apparatus comprising a liquid droplet ejection head module comprising:
a plurality of ejection surfaces, each ejection surface comprising a pair of first sides extending in a direction intersecting with a first direction, and a pair of second sides linking the pair of first sides and extending in a direction inclined with respect to the first direction;
first nozzles that are provided on the plurality of ejection surfaces and arranged in the direction inclined to the first direction and in a direction substantially orthogonal to the first direction, and that eject first liquid droplets; and
second nozzles that are provided on the plurality of ejection surfaces so as to be further downstream in the first direction than the first nozzles and arranged in the direction inclined to the first direction and in the direction substantially orthogonal to the first direction, and that eject second liquid droplets,
wherein, when the plurality of ejection surfaces are linearly arranged such that the second sides overlap and the first nozzles are projected in a direction orthogonal to the first direction, the projected first nozzles are arranged in equal intervals in the direction orthogonal to the first direction, and when the second nozzles are projected in the direction orthogonal to the first direction, the projected second nozzles are arranged in equal intervals in the direction orthogonal to the first direction.
